(19) United States
(12) Patent Application Publication
(10) Pub. No.: US 2005/0262218 A1
(43) Pub. Date: Nov. 24, 2005

(54) System and method for DHCP-based assignment of IP addresses to servers based on geographic identifiers

(76) Inventors: Gabriel C. Cox, The Woodlands, TX (US); Daniel W. Eaton, The Woodlands, TX (US); Jonathan J. Nalley, The Woodlands, TX (US); Stephen P. Rousset, Round Rock, TX (US)

Correspondence Address: BAKER BOTTS L.L.P., 2001 ROSS AVENUE, SUITE 600, DALLAS, TX, 75201-2980, US

(21) Appl. No.: 10/837,114

(22) Filed: Apr. 30, 2004

(51) Int. Cl. G06F 15/16

(52) U.S. Cl. 709/217

(57) ABSTRACT

A method of assigning IP addresses to a plurality of managed servers coupled is provided. A set of address correlations is stored, at least temporarily, at a management server coupled to the managed servers. Each address correlation comprises a correlation between one of a plurality of geographic identifiers and one of a plurality of IP addresses. Each geographic identifier identifies a possible physical location of a managed server. A geographic identifier at least partially identifying the physical location of the managed server is received at the management server from a particular managed server. The IP address corresponding to the received geographic identifier is determined from the set of address correlations and assigned to the particular managed server.

### TECHNICAL FIELD OF THE INVENTION

The present invention relates generally to the assignment of IP addresses and, more particularly, to a system and method for DHCP-based assignment of IP addresses to servers based on geographic identifiers.

### BACKGROUND OF THE INVENTION

Managing IP addresses for large numbers of servers presents several issues. First, each server must be booted and the network configuration on the server must be manually accessed, either by manually logging into the server or using some automated means of modifying the network configuration on the server. As the number of servers being managed increases, the task of assigning and managing IP addresses for such servers becomes more difficult. The problem is further complicated by the fact that modification of the network configuration on various servers is performed differently in disparate operating systems.

### SUMMARY OF THE INVENTION

The present invention provides a system and method for DHCP-based assignment of IP addresses to servers based on geographic identifiers. In accordance with a particular embodiment of the present invention, IP addresses are assigned to managed servers coupled to a DHCP management server based on the geographic location of each managed server. Each DHCP entry may comprise a correlation between a static IP address corresponding with a particular geographic location and the MAC address of the managed server located in that particular geographic location.

In one embodiment, a method of assigning IP addresses to a plurality of managed servers coupled is provided. A set of address correlations is stored, at least temporarily, at a management server coupled to the managed servers. Each address correlation comprises a correlation between one of a plurality of geographic identifiers and one of a plurality of IP addresses. Each geographic identifier identifies a possible physical location of a managed server. A geographic identifier at least partially identifying the physical location of the managed server is received at the management server from a particular managed server. For example, the geographic identifier may identify the particular slot, the particular chassis, and the particular rack in which the managed server is located. The IP address corresponding to the received geographic identifier is determined from the set of address correlations and assigned to the particular managed server.

In certain embodiments, a MAC address associated with the managed server is received at the management server from the managed server and a second address correlation is created between the received MAC address and the particular IP address determined to correspond to the received geographic identifier. Thus, when the management server receives a request from the managed server for an IP address, which request includes the MAC address associated with the managed server, the management server may identify the particular IP address assigned to the managed server based on the MAC address received in the request and the second address correlation. The identified particular IP address may then be communicated to the managed server.

In particular embodiments, the management server is a DHCP management server and each managed server acts as a DHCP client with respect to the DHCP management server.

Technical advantages of the present invention include a system and method for assigning and managing IP addresses for a plurality of servers. The IP addresses for the plurality of servers, which may be referred to as managed servers, may be assigned and managed at a single DHCP management server connected to each of the plurality of managed servers, rather than at each managed server. Thus, the need for logging into each managed server to set or adjust the network configurations associated with such managed servers, including the IP address for such managed servers, may be reduced or eliminated. As a result, operational efficiency may be increased, particularly when managing a large number of managed servers. In addition, unlike with prior methods of configuring IP addresses for servers, a managed server need not be online or booted up in order to set or modify the IP address for that managed server.

Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following descriptions, taken in conjunction with the accompanying drawings, in which:

FIG. 1 is a schematic drawing illustrating a system for DHCP-based assignment of IP addresses to a plurality of servers in accordance with a particular embodiment of the present invention;

FIG. 2 is a schematic drawing illustrating a DHCP management server, a managed server, and a process of assigning an IP addresses to the managed server in accordance with a particular embodiment of the present invention;

FIG. 3 illustrates a table of static address correlations between example IP addresses and example geographic identifiers; and

FIG. 4 illustrates a table of dynamic address correlations between example MAC addresses of managed servers and example IP addresses assigned to geographic locations in which such managed servers are located.

### DETAILED DESCRIPTION OF THE INVENTION

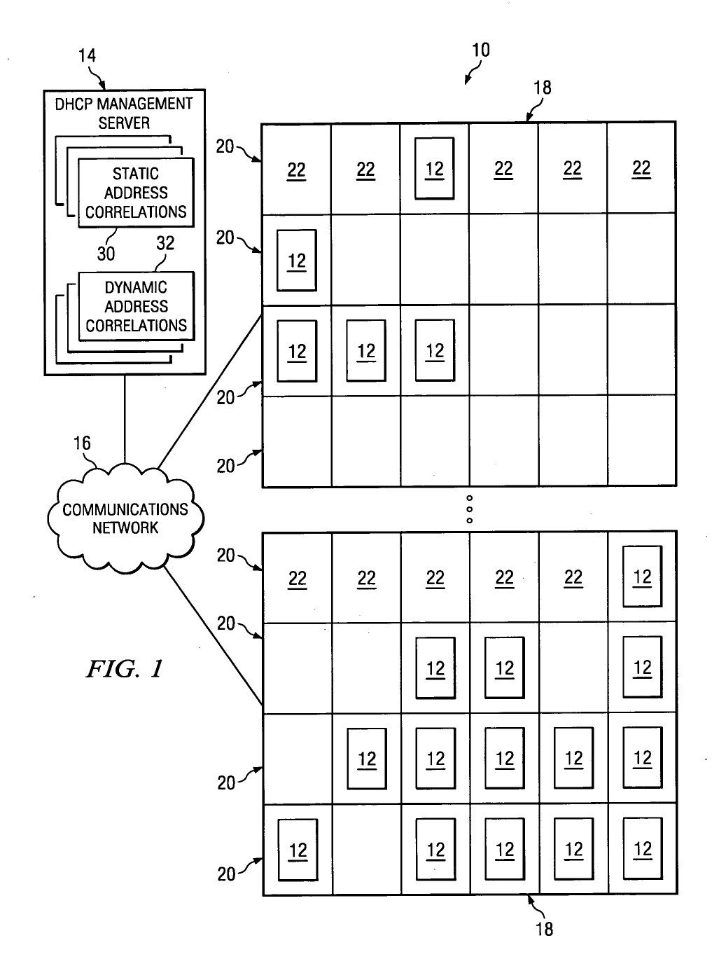

FIG. 1 is a schematic drawing illustrating a system 10 for DHCP-based assignment of IP addresses to a plurality of servers in accordance with a particular embodiment of the present invention. System 10 includes a plurality of managed servers 12 coupled to a DHCP management server 14 via a communications network 16. As discussed in greater detail below, with respect to the assignment of IP addresses, managed servers 12 act as DHCP clients of DHCP management server 14. In other words, DHCP management server 14 manages the DHCP-based assignment of IP addresses for managed servers 12.

Managed servers 12 may comprise any type of network servers, such as web servers, disk servers, file servers, database servers, transaction servers, or application servers, for example. Managed servers 12 may be located generally at a single physical location or physically distributed across multiple locations. In the embodiment shown in FIG. 1, managed servers 12 are server blades inserted in one or more chassis 20. A particular rack 18 may include a plurality of chassis 20, each chassis 20 including a number of slots 22 into which managed servers 12 may be inserted in order to communicate via communications network 16. Thus, each managed server 12 is located within a particular slot 22, in a particular chassis 20, and in a particular rack 18.

The rack 18, chassis 20, and slot 22 in which a managed server 12 is located may be referred to as the geographic location of the managed server 12. However, it should be understood that in other embodiments, the geographic location of managed servers 12 may be defined by one or more physical parameters other than rack, chassis, and slot without departing from the invention. For example, the geographic location of managed servers 12 may be defined by row, column, and rack parameters; by shelf, slot, and rack parameters; or by any other suitable physical parameters.

As discussed above, DHCP management server 14 manages the assignment of IP addresses for managed servers 12 according to the DHCP protocol. In certain embodiments, DHCP management server 14 manages static address correlations 30 and dynamic address correlations 32 in order to manage the assignment of IP addresses for managed servers 12. Static address correlations 30 associate particular static IP addresses (which may be changed over time) with particular geographic locations of managed servers 12, such as various slots 22 in various chassis 20 within various racks 18. Static IP addresses may be assigned to geographic locations (such as particular slots 22 in a rack 18) and may be maintained regardless of the particular managed servers 12 inserted into such geographic locations. Static address correlations 30 may be predetermined and/or may be changed over time, such as by an administrator or other user.

Dynamic address correlations 32 associate MAC addresses associated with managed servers 12 with the static IP addresses discussed above. In particular, each dynamic address correlation 32 may associate the MAC address associated with a particular managed server 12 with the static IP address corresponding with the geographic location of the particular managed server 12, as defined by static address correlations 30. DHCP management server 14 creates dynamic address correlations 32 (or in other words, creates dynamic DHCP entries) based on (1) geographic information and (2) MAC address information received from managed servers 12 when such managed servers 12 are inserted into geographic locations within system 10. Unlike static address correlations 30, dynamic address correlations 32 are dynamically created by DHCP management server 14 as different managed servers 12 are inserted into particular geographic locations (such as particular slots 22 in a rack 18). For example, when a first managed server 12 is inserted into a particular slot 22, DHCP management server 14 creates a dynamic address correlation 32 between the MAC address of the first managed server 12 and the IP address corresponding to the particular slot 22 (as defined by a static address correlation 30). If the first managed server 12 is later removed and a second managed server 12 inserted into the same slot 22, DHCP management server 14 creates a new, different dynamic address correlation 32 between the MAC address of the second managed server 12 and the IP address corresponding to the particular slot 22 (as defined by a static address correlation 30).

Communication network 16 couples and facilitates wireless or wireline communication between managed servers 12 and DHCP management server 14. Communication network 16 may include one or more servers, routers, switches, repeaters, backbones, links and/or any other appropriate type of communication devices coupled by links such as wire line, optical, wireless, or other appropriate links. In general, communication network 16 may include any interconnection found on any communication network, such as a local area network (LAN), metropolitan area network (MAN), wide area network (WAN), the Internet, portions of the Internet, or any other data exchange system.

In operation, DHCP management server 14 may manage the assignment of IP addresses for managed servers 12 as follows. A set of static address correlations 30 associating static IP addresses with geographic identifiers identifying possible geographic locations for managed servers 12 may be generated and stored at the DHCP management server 14. For example, geographic identifiers may be in the form of “Rack-Chassis-Slot” such that each geographic identifier identifies a particular slot 22 in a particular chassis 20 in a particular rack 18.

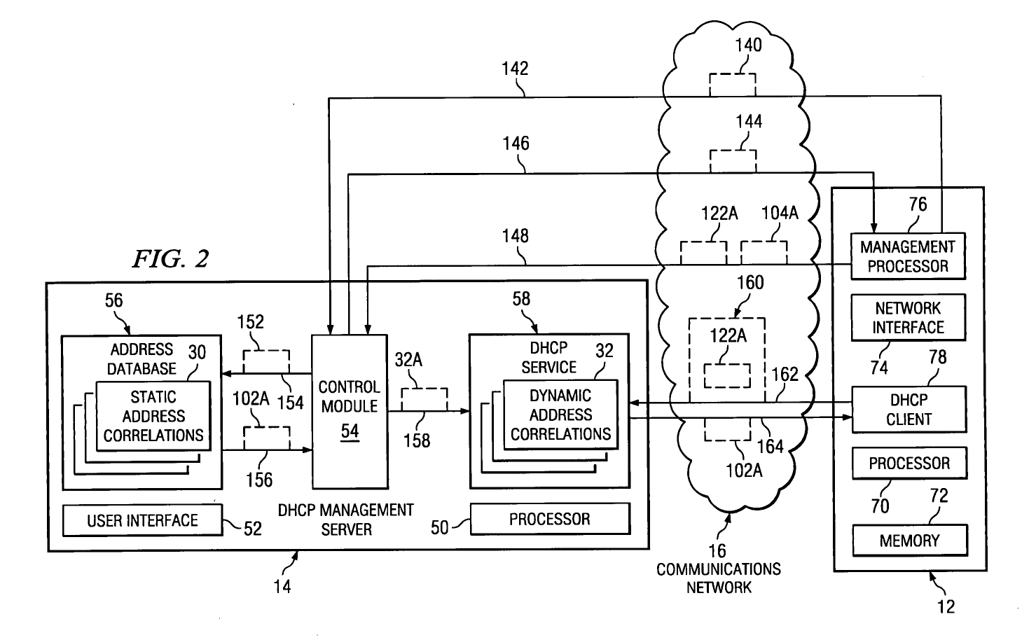

When a managed server 12 is inserted into a particular geographic location, a management processor on managed server 12 (discussed in greater detail below with reference to FIG. 2) receives power the managed server 12 communicates to DHCP management server 14 an initialization notification indicating that the management processor is online. The management processor on managed server 12 has access to the MAC address associated with managed server 12, which may be the MAC address of a network interface device (such as an Ethernet card, for example) on managed server 12. In response, DHCP management server 14 requests from the management processor the following information: (1) a geographic identifier that identifies the particular geographic location into which managed server 12 has been inserted, and (2) the MAC address associated with managed server 12. In response, the management processor on managed server 12 provides the requested geographic identifier and MAC address to DHCP management server 14. In alternative embodiments, the management processor on managed server 12 may provide DHCP management server 14 the geographic identifier and MAC address automatically (i.e., without a request from DHCP management server 14) upon power-up or other initialization of the management processor.

DHCP management server 14 then identifies the IP address corresponding to the geographic identifier received from managed server 12 according to the set of static address correlations 30. DHCP management server 14 assigns the identified IP address to managed server 12 by creating and storing a dynamic address correlation 32 between the identified IP address and the MAC address received from managed server 12. In certain embodiments, dynamic address correlation 32 is a host lease between the identified IP address and MAC address that expires after a particular period of time.

When managed server 12 boots up, or comes online, a DHCP client on managed server 12 (discussed in greater detail below with reference to FIG. 2) requests an IP address from DHCP management server 14 to be used for the management of managed server 12. The request includes the MAC address associated with managed server 12. In response to the request, DHCP management server 14 identifies the IP address corresponding to the MAC address received in the request based on the dynamic address correlation 32 created and stored by DHCP management server 14 as discussed above. DHCP management server 14 then communicates the identified IP address to the DHCP client on managed server 12, and the IP address may then be used for communications between management server 14 and managed server 12.

If managed server 12 is subsequently removed from its slot 22 and another managed server 12 is inserted into that slot 22, the process repeats and DHCP management server 14 assigns the same IP address to the new managed server 12 by creating and storing a new dynamic address correlation 32 between the IP address and the MAC address of the new managed server 12. Thus, dynamic address correlations 32 are created and changed dynamically as managed servers 12 are inserted into, removed from, or moved to new geographic locations (such as new slots 22, for example). In contrast, static address correlations 30 do not automatically change upon the insertion, removal, or rearrangement of managed servers 12 within various geographic locations. Instead, static address correlations 30 may be managed periodically by a user, such as an administrator for example, via a user interface (discussed in greater detail below with reference to FIG. 2) associated with DHCP management server 14. Thus, a user may manage IP addresses for multiple managed servers 12 through DHCP management server 14 rather than modifying the network configuration on each managed server 12.

FIG. 2 is a schematic drawing illustrating DHCP management server 14, a managed server 12, and a process of assigning an IP addresses to managed server 12 in accordance with a particular embodiment of the present invention. As discussed above, DHCP management server 14 and managed server 12 are coupled via communications network 16, which allows wireless and/or wireline communications. DHCP management server 14 includes a processor 50, a user interface 52, a control module 54, an address database 56, and a DHCP service 58. Managed server 12 includes a processor 70, memory 72, a network interface 74, a management processor 76, and a DHCP client 78.

Regarding DHCP management server 14, processor 50 is generally operable to execute various software, algorithms, or other computer instructions associated with various components of DHCP management server 14, such as user interface 52, control module 54, address database 56 and/or DHCP service 58, for example, to manage the assignment of IP addresses to managed servers 12. Processor 50 may comprise any suitable processor that executes software, algorithms, or other computer instructions, such as a central processing unit (CPU) or other microprocessor, and may include any suitable number of processors working together.

User interface 52 provides an interface for users, such as network administrators for example, to provide input to and receive feedback from DHCP management server 14. For example, user interface 52 may provide an interface for a user to create, alter and/or otherwise manage static address correlations 30 between IP addresses and geographic identifiers identifying geographic locations. User interface 52 may include any suitable hardware and/or software to provide such an interface for user input and/or feedback.

Control module 54 may perform various functions associated with assigning IP addresses to managed servers 12, such as, for example, communicating requests to managed servers 12 for MAC addresses and geographic identifiers associated with such managed servers 12, cooperating with address database 56 to look up IP addresses corresponding with particular geographic identifiers, creating dynamic address correlations between IP addresses and MAC address of new managed servers 12 and/or cooperating with user interface 52 to manage static address correlations 30 based on input from users. Control module 54 may include any suitable hardware and/or software for performing any such functions or any other functions associated with assigning IP addresses to managed servers 12.

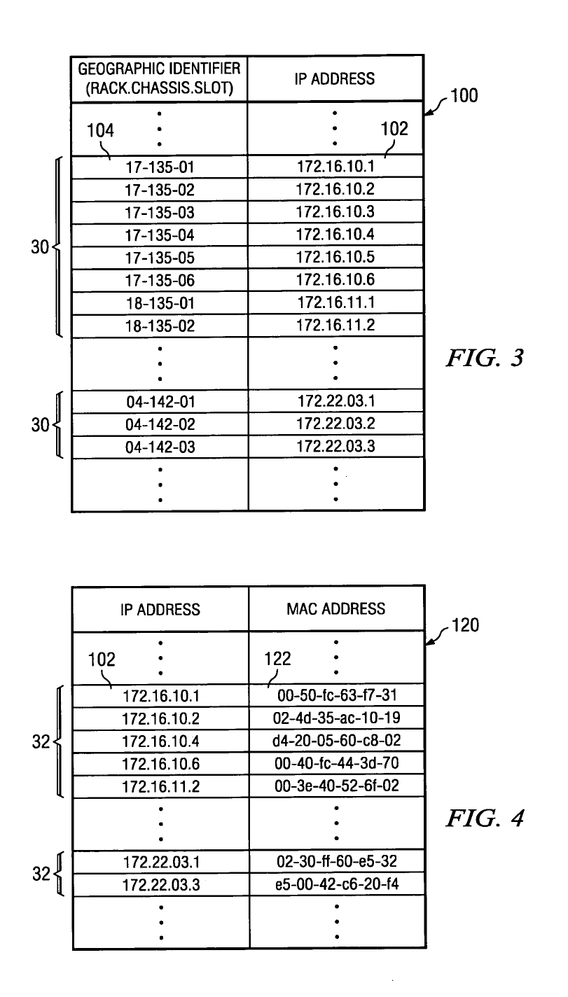

Address database 56 comprises any suitable memory device or devices operable to store static address correlations 30 between IP addresses and geographic identifiers identifying geographic locations. FIG. 3 illustrates a table 100 of static address correlations 30 between example IP addresses 102 and example geographic identifiers 104 in accordance with a particular embodiment of the invention. Table 100 may be stored or maintained by address database 56. Each row in table 100 identifies a static address correlation 30 associating a particular IP address 102 with a particular geographic identifier 104. The format of each geographic identifier 104 shown in table 100 is “Rack-Chassis-Slot.” Thus, for example, the first geographic identifier 104 shown in table 100 identifies slot #01 in chassis #135 in rack #17.

In certain embodiments, the IP address 102 associated with each geographic identifier 104 may be selected and managed over time, such as by a network administrator, for example. For instance, a network administrator may change the IP addresses 102 corresponding to particular geographic identifiers 104 to make room for new geographic identifiers 104. In addition, in certain embodiments, a network administrator may use an algorithm to change some or all of IP addresses 102 corresponding to particular geographic identifiers 104, such as by adding an offset to one or more parameters of such geographic identifiers 104 in order to change the IP addresses 102 associated with such geographic identifiers 104. For example, in an embodiment in which IP addresses 102 are generated from geographic identifiers 104 using a template having the format of “10.Rack.Chassis.Slot” (i.e., where the IP addresses generated from a geographic identifier of “17-135-02” is “10.17.135.02”), a network administrator may use an algorithm to add an offset of 20 to the “Slot” parameter of the “10.Rack.Chassis.Slot” template for generating IP addresses 102. Thus, the IP address for a geographic identifier of “17-135-02” would be changed from “10.17.135.02” to “10.17.135.22.” In this manner, a network administrator may be able to easily change the IP addresses 102 corresponding to particular groups of (or all) geographic identifiers 104.

Returning to FIG. 2, DHCP service 58 allows managed servers 12 to dynamically set network configuration parameters. In particular, DHCP service allows DHCP management server 14 to allocate and assign IP addresses 102 and other parameters to managed servers 12 that dynamically connect to system 10. In certain embodiments, DHCP service 58 stores a set of dynamic address correlations 32 created by control module 54 between IP addresses 102 and MAC addresses of managed servers 12. DHCP service 58 may be operable to receive a broadcast IP address request from a managed server 12, which request includes the MAC address of the managed server 12, to determine the particular IP address 102 corresponding to the MAC address according to the dynamic address correlations 32, and to communicate the IP address 102 to the managed server 12. In addition, in embodiments in which dynamic address correlations 32 are temporary leases, DHCP service 58 may also define or control the duration and/or expiration of such leases. DHCP service 54 may include any suitable software for facilitating the assignment of IP addresses 102 to managed servers 12. In some embodiments, some of the functions discussed above are performed according to DHCP standard protocol RFC 2131.

FIG. 4 illustrates a table 120 of dynamic address correlations 32 between example MAC addresses 122 of managed servers 12 within system 10 and example IP addresses 102 corresponding to geographic locations in which such managed servers 12 are located. Table 120 may be maintained and/or managed by DHCP service 58. Each row in table 120 identifies a dynamic address correlation 32 associating the MAC address 122 of a particular managed server 12 connected to system 10 with the IP address 102 assigned (according to a particular static address correlation) to the geographic identifier 104 of the geographic location in which that managed server 12 is located. Thus, for example, assume a particular managed server 12 having the MAC address “00-50-fc-63-f7-31” is inserted into slot #01 in chassis #135 in rack #17, which location is identified by the geographic identifier “17-135-01” according to the “Rack-Chassis-Slot” format. Referring to the first dynamic address correlation 32 shown in table 120, the managed server 12 is assigned the IP address “172.16.10.1” since that IP address is assigned to the geographic identifier “17-135-01,” according to the first static address correlation 30 shown in table 100. In certain embodiments, this dynamic address correlation 32 will be maintained until either (1) the managed server 12 is physically removed from the particular slot 22, or (2) the static address correlation 30 associating the IP address “172.16.10.1” with the geographic identifier “17-135-01” is modified, such as discussed above with reference to FIG. 3.

The components of DHCP management server 14, including processor 50, user interface 52, control module 54, address database 56 and/or DHCP service 58, may be co-located or physically and/or geographically distributed. In addition, individual components of DHCP management server 14 may be physically and/or geographically distributed. For example, address database 56 may include multiple databases at different physical locations.

Regarding managed server 12, processor 70 is generally operable to execute various software, algorithms, or other computer instructions associated with various components of managed server 12, such as memory 72, network interface 74 and/or DHCP client 78, for example. Processor 70 may comprise any suitable processor that executes software, algorithms, or other computer instructions, such as a central processing unit (CPU) or other microprocessor, and may include any suitable number of processors working together. Memory 72 may comprise one or more memory devices suitable to facilitate execution of the computer instructions, such as one or more random access memory modules (RAMs), read-only memory modules (ROMs), dynamic random access memory modules (DRAMs), fast cycle RAMs (FCRAMs) , static RAM (SRAMs), field-programmable gate arrays (FPGAs), erasable programmable read-only memory modules (EPROMs), electrically erasable programmable read-only memory modules (EEPROMs), microcontrollers, or microprocessors.

Network interface 74 comprises any suitable hardware and/or software for interfacing with communications network 16. For example, network interface 74 may comprises one or more network interface cards (NICs). In particular embodiments, network interface 74 comprises an Ethernet interface. Network interface 74 may have an associated static MAC address 122. For example, a static MAC address 122 may be programmed into network interface 74.

Management processor 76 is generally operable to communicate information regarding managed server 12 to DHCP management server 14 in order for DHCP management server 14 to assign an IP address 102 to managed server 12. Management processor 76 may access the MAC address 122 associated with network interface 74 in order to communicate such MAC address 122 to DHCP management server 14, as discussed below in greater detail. In some embodiments, the static MAC address 122 associated with network interface 74 is programmed into management processor 76 prior to the insertion of managed server 12 into system 10, such as during the manufacturing of managed server 12, for example. In other embodiments, management processor 76 is coupled to network interface 74 such that management processor 76 is operable to obtain the MAC address 122 from network interface 74 on demand.

Management processor 76 also includes software for detecting the geographic location of the managed server 12 once the managed server 12 has been inserted into a particular geographic location. For example, in certain embodiments, once managed server 12 is inserted into a slot 22 in a chassis 20, management processor 76 is operable to obtain from the chassis 20 a geographic identifier 104 identifying the particular rack 18, the particular chassis 20, and the particular slot 22 in which the managed server 12 has been inserted. Alternatively, management processor 76 may be operable to detect the geographic location (such as the particular rack 18, chassis 20, and slot 22, for example) in which the managed server 12 has been inserted, and to generate a geographic identifier 104 indicating the detected geographic location.

In particular embodiments, the format of the geographic identifier 104 is “Rack-Chassis-Slot,” where “Rack” identifies the particular rack 18, “Chassis” identifies the particular chassis 20, and “Slot” identifies the particular slot 22. For example, if managed server 12 is inserted into slot #12 in chassis #126 in rack #55, the geographic identifier 104 for the location of managed server 12 may be “55-126-12.” However, geographic identifier 104 may have any format suitable to at least partially identify the location of managed server 12.

In certain embodiments, management processor 76 boots up, or comes online, as soon as management processor 76 receives power due to managed server 12 being inserted into a slot 22. Once this power-on event occurs, management processor 76 is operable to notify DHCP management server 14 that management processor 76 has been powered on, to obtain the geographic identifier 104 identifying the geographic location of managed server 12 (such as discussed above), and to communicate (1) the geographic identifier 104 and (2) the managed server's MAC address 122 to DHCP management server 14.

DHCP client 78 is generally operable to cooperate with DHCP service 58 such that various parameters of managed server 12 can be configured by DHCP management server 14. In certain embodiments, once managed server 12 boots up (which may occur at some time after managed server 12 is inserted into its slot 22, and thus after management processor 76 boots up), DHCP client 78 sends a broadcast request for an IP address 102 via communications network 16. The request may include the MAC address 122 associated with managed server 12. DHCP client 78 may then receive from DHCP service 58 the IP address 102 identified for managed server 12 by DHCP service 58. DHCP client 78 may then configure one or more components of managed server 12, including network interface 74, to use the identified IP address 102.

In addition to illustrating the components of DHCP management server 14 and managed server 12, FIG. 2 illustrates an example method of DHCP management server 14 assigning an IP addresses 102 to managed server 12. At some point subsequent to managed server 12 being inserted into system 10 (such as during the setup of DHCP management server 14, for example), a set of static address correlations 30 between IP addresses 102 and geographic identifiers 104 identifying geographic locations are generated and stored in address database 56. In certain embodiments, a user (such as an administrator, for example) manages the generation of such static address correlations 30. For example, the user may select particular IP addresses 102 for particular geographic locations. The selection of IP addresses 102 for particular geographic locations may be fully or partially automated, such as using various algorithms and/or templates to facilitate the generation of large numbers of static address correlations 30. In certain embodiments, a user may use one or more templates to generate IP addresses 102 for various geographic identifiers 104. For example, a template may have the format “10.Rack.Chassis.Slot” such that for a geographic identifier 104 of “17-135-01,” an IP address 102 of “10.17.135.01” is generated. As another example, a template may have the format “10.Rack.Chassis.Slot+20” such that for the geographic identifier 104 of “17-135-01,” an IP address 102 of “10.17.135.21” is generated.

In some embodiments, a user may be able to create and/or alter the format of such templates used to generate IP addresses 102 from geographic identifiers 104. For example, a user may be able to add an offset to one or more particular parameters of such templates in order to alter the IP addresses 102 assigned to particular geographic identifiers 104. For instance, the user may add an offset of 20 to the “Slot” component of the template format by changing the template format from “10.Rack.Chassis.Slot” to “10.Rack.Chassis.Slot+20” for a particular group of geographic identifiers 104. Thus, the IP addresses 102 assigned to each of that group of geographic identifiers 104 would be changed. For example, for a geographic identifier 104 of “17-135-01,” the corresponding IP address 102 would change from “10.17.135.01” to “10.17.135.21.” Similarly, for a geographic identifier 104 of “18-45-03,” the corresponding IP address 102 would change from “10.18.45.03” to “10.18.45.23.”

At some time after static address correlations 30 have been established, managed server 12 is inserted into a particular slot 22 in a particular chassis 20 in a particular rack 18 in system 10. Once managed server 12 is inserted into slot 22, management processor 26 receives power and boots up, or powers on, before processor 70 of managed server 12 is booted up. Management processor 26 communicates an initialization notification 140 to control module 54 of DHCP management server 14, as indicated by arrow 142, indicating that management processor 26 has been initialized. Such initialization may comprise a start-up event, a power-on event, a reset event, or any other event selected to trigger the communication process between managed server 12 and DHCP management server 14.

In addition, management processor 26 obtains a geographic identifier 104 identifying the particular rack 18, chassis 20, and the slot 22 in which managed server 12 is inserted, such as described above. This geographic identifier may be referred to as geographic identifier 104A. In certain embodiments, geographic identifier 104A (or at least a portion of geographic identifier 104A) is programmed into the chassis 20 such that management processor 26 can communicate with software associated with chassis 20 in order to identify one or more of the rack 18, chassis 20, and slot 22 in which managed server 12 is located.

In response to receiving initialization notification 140 from management processor 76, control module 54 communicates a request 144 to management processor 76, as indicated by arrow 146, for particular information regarding managed server 12, including (1) the MAC address 122 associated with network interface 74 of managed server 12, and (2) the geographic identifier 104 identifying the geographic location of managed server 12. In response to receiving request 144, management processor 76 communicates (1) the MAC address 122 associated with network interface 74, indicated as MAC address 122A, and (2) geographic identifier 104A to control module 54, as indicated by arrow 148. As discussed above, management processor 76 has access to MAC address 122A such that management processor 76 may communicate MAC address 122A to control module 54.

After receiving MAC address 122A and geographic identifier 104A from management processor 76, control module 54 sends a lookup request 152 to address database 56, as indicated by arrow 154, to identify the IP address 102 corresponding to MAC address 122A. In response to receiving lookup request 152, address database 56 identifies the IP address 102 corresponding to MAC address 122A according to the set of static address correlations 30 stored in address database 56. The identified IP address 102 may be referred to as IP address 102A. Address database 56 sends the identified IP address 102A to control module 54, as indicated by arrow 156.

After receiving IP address 102 from address database 56, control module 54 creates a dynamic address correlation 32A between MAC address 122A and IP address 102 and communicates the dynamic address correlation 32A to DHCP service 58, as indicated by arrow 158. DHCP service 58 stores dynamic address correlation 32A. As discussed above, in certain embodiments, dynamic address correlation 32A is a host lease that expires after a particular duration that may be defined and/or managed by DHCP service 58.

At some subsequent time, processor 70 of managed server 12 is booted up. As a result, DHCP 78 broadcasts an IP request 160 (which may be referred to as a DHCP request) via communications network 16, as indicated by arrow 162. IP request 102 includes MAC address 122A. DHCP service 58 receives IP request 160 and identifies, based on the set of dynamic address correlations 32 maintained by DHCP service 58, the IP address 102 corresponding to MAC address 122A. In particular, DHCP service 58 determines that IP address 102A corresponds to MAC address 122A according to dynamic address correlation 32A generated by control module 54 as discussed above. DHCP service 58 communicates the identified IP address 102A to DHCP client 78, as indicated by arrow 164. DHCP client 78 may then notify one or more components of managed server 12, including network interface 74, of the leased IP address 102A.

Throughout the operation of managed server 12, DHCP client 78 makes subsequent IP requests 162 to confirm that IP address 102A remains leased to managed server 12. After some predetermined duration, the leased dynamic address correlation 32A expires. However, assuming the static address correlation 30 associating IP address 102A with geographic identifier 104A has not been changed in the interim (such as by an administrator), IP address 102A will be re-leased to managed server 12 upon the first IP request 162 received from DHCP client 78 after the expiration of the original lease. Thus, in certain embodiments, dynamic address correlation 32A will be maintained until either (1) managed server 12 is physically removed from the slot 22, or (2) the static address correlation 30 associating IP address 102A with geographic identifier 104A is changed, such as discussed below.

At various times during the operation of system 10, a user (such as by a network administrator, for example) may modify the static address correlation 30 assigning IP address 102A to geographic identifier 104A. For example, a network administer may modify the IP addresses 102 assigned to particular geographic identifiers 104 in order to make room for a new group of geographic identifiers 104. Thus, a new IP address 102, which may be indicated as IP address 102B is assigned to geographic identifier 104A to replace IP address 102A. In response, control module 54 generates a new dynamic address correlation 32B assigning IP address 102B to MAC address 122A. This new dynamic address correlation 32B is then communicated to DHCP service 58, which replaces (or modifies) dynamic address correlation 32A with the new dynamic address correlation 32B. In such an event, DHCP service 58 may provide DHCP client 78 the new IP address 102B upon the first subsequent IP request 162 received from DHCP client 78. Thus, the IP address 102 assigned to managed server 102 is automatically updated by DHCP management server 14 without requiring a user to manually reconfigure managed server 102.

In this manner, IP addresses 102 for a plurality of managed servers 12 may be assigned and managed at a single DHCP management server 14, rather than at each managed server 12. Thus, the need for logging into each managed server 12 to set or adjust the network configurations associated with such managed servers 12 may be reduced or eliminated, thus increasing efficiency and reducing expenses, particularly when managing a large number of servers. In addition, unlike with prior methods of configuring IP addresses for servers, a managed server 12 need not be online or booted up in order to set or modify the IP address for that managed server 12.

Although the discussion herein focuses on assigning IP address to managed servers 12 based on geographic identifiers identifying the location of such managed servers 12, in other embodiments IP address may be assigned to managed servers 12 based on other types of meaningful identifiers that the management processors 76 of such managed servers 12 may provide, along with the MAC address 122 of such managed servers 12, to DHCP management server 14. Such meaningful identifiers may be used to identify managed servers 12 from each other and may be given to each managed server 12 by a user, such as an administrator. For example, meaningful identifiers may include names given to each managed server 12 by a user, such as “Server #1,” “Server #2,” etc., that may be used by the user to identify each managed server 12. As another example, the meaningful identifier of each managed server 12 may be the serial number of that managed server 12, which may be known by a user such that the user may identify each managed server 12. In such embodiments, static address correlations 30 may be made between IP addresses 102 and such meaningful identifiers that identify managed servers 12, rather than between IP addresses 102 and geographic identifiers 104. In addition, in such embodiments, as discussed above, the generation of such static address correlations 30 may be performed or managed by a user, such as an administrator, for example.

Although the present invention has been described in several embodiments, a myriad of changes and modifications may be suggested to one skilled in the art, and it is intended that the present invention encompass such changes and modifications as fall within the scope of the present appended claims.

1. A method, comprising:
storing, at least temporarily, a set of first address correlations, each first address correlation comprising a correlation between one of a plurality of geographic identifiers and one of a plurality of IP addresses, each geographic identifier identifying a possible physical location of a managed server;
receiving at a management server from a managed server a geographic identifier at least partially identifying the physical location of the managed server;
determining from the set of first address correlations the particular IP address corresponding to the received geographic identifier; and
assigning the particular IP address to the managed server.

2. The method of claim 1, wherein the management server comprises a DHCP management server.

3. The method of claim 1, further comprising:
receiving at the management server from the managed server a MAC address associated with the managed server; and
creating a second address correlation between the received MAC address and the particular IP address determined to correspond to the received geographic identifier.

4. The method of claim 3, wherein the geographic identifier and the MAC address associated with the managed server are received at the management server from a management processor of the managed server.

5. The method of claim 3, wherein the geographic identifier and the MAC address associated with the managed server are received at the management server from the managed server in response to a management processor associated with the managed server being powered on.

6. The method of claim 3, further comprising:
receiving at the management server a request from the managed server for an IP address for the managed server, the request including the MAC address associated with the managed server;
using the MAC address received in the request and the second address correlation to identify the particular IP address assigned to the managed server; and
communicating the identified particular IP address to the managed server.

7. The method of claim 6, wherein the request is received automatically from the managed server in response to the managed server booting up.

8. The method of claim 6, wherein:
the request is received by a DHCP service associated with the management server from a DHCP client associated with the managed server; and
the particular IP address assigned to the managed server is identified and communicated to the DHCP client by the DHCP service.

9. The method of claim 3, wherein:
creating a second address correlation between the received MAC address and the particular IP address comprises creating a host lease between the received MAC address and the particular IP address, the host lease expiring after a period of time; and
the method further comprises, after the host lease expires:
receiving at the management server a new request from the managed server for an IP address for the managed server, the new request including the MAC address associated with the managed server;
using the MAC address received in the new request and the second address correlation to identify the particular IP address assigned to the managed server; and
communicating the identified particular IP address to the managed server.

10. The method of claim 1, further comprising:
receiving at the management server an initialization notification that a management processor associated with the managed server is initialized;
in response to receiving the initialization notification, requesting from the managed server a MAC address associated with the managed server; and
receiving from the managed server the MAC address associated with the managed server.

11. The method of claim 10, further comprising creating a second address correlation between the received MAC address and the particular IP address determined to correspond to the received geographic identifier.

12. The method of claim 10, wherein the initialization notification is received automatically from the management processor in response to the management processor receiving power upon insertion of the managed server into a physical server location.

13. The method of claim 1, wherein:
the managed server is located in a particular slot in a particular chassis in a particular rack; and
the geographic identifier identifies the particular slot, the particular chassis, and the particular rack.

14. A method, comprising:
storing, at least temporarily, a set of first address correlations, each first address correlation comprising a correlation between one of a plurality of unique meaningful identifiers and one of a plurality of IP addresses, each unique meaningful identifier identifying one of a plurality of managed servers;
receiving at a management server from a managed server a unique meaningful identifier identifying a particular managed server from the plurality of managed servers;
determining from the set of first address correlations the particular IP address corresponding to the received unique meaningful identifier; and
assigning the particular IP address to the particular managed server.

15. The method of claim 14, wherein the management server comprises a DHCP management server.

16. The method of claim 14, further comprising:
receiving at the management server from the particular managed server a MAC address associated with the particular managed server; and
creating a second address correlation between the received MAC address and the particular IP address determined to correspond to the received unique meaningful identifier.

17. The method of claim 16, wherein the unique meaningful identifier and the MAC address associated with the particular managed server are received at the management server from a management processor of the particular managed server.

18. The method of claim 16, further comprising:
receiving at the management server a request from the particular managed server for an IP address for the particular managed server, the request including the MAC address associated with the particular managed server;
using the MAC address received in the request and the second address correlation to identify the particular IP address assigned to the particular managed server; and
communicating the identified particular IP address to the particular managed server.

19. A system for assigning IP addresses to a plurality of managed servers, the system comprising a management server, the management server including:
memory operable to store, at least temporarily, a set of first address correlations, each first address correlation comprising a correlation between one of a plurality of geographic identifiers and one of a plurality of IP addresses; and
a control module, the control module coupled to the memory and operable to:
receive from a particular managed server coupled to the management server a geographic identifier at least partially identifying the physical location of the particular managed server; and
determine from the set of first address correlations the particular IP address corresponding to the received geographic identifier.

20. The system of claim 19, wherein the management server comprises a DHCP management server.

21. The system of claim 19, wherein the control module of the management server is further operable to:
receive from the particular managed server a MAC address associated with the particular managed server; and
create a second address correlation between the received MAC address associated with the particular managed server and the particular IP address determined to correspond to the geographic identifier at least partially identifying the physical location of the particular managed server.

22. The system of claim 21, wherein the geographic identifier and the MAC address associated with the particular managed server are received at the control module of the management server from a management processor of the particular managed server.

23. The system of claim 21, wherein the geographic identifier and the MAC address associated with the particular managed server are received at the control module of the management server from the particular managed server in response to a management processor associated with the particular managed server being powered on.

24. The system of claim 21, wherein the management server further includes a DHCP service coupled to the control module and operable to:
receive from the particular managed server a request for an IP address for the particular managed server, the request including the MAC address associated with the particular managed server;
identify the particular IP address determined to correspond to the received geographic identifier based at least on the MAC address received in the request and the second address correlation between that MAC address and the particular IP address; and
cause the identified particular IP address to be communicated to the particular managed server.

25. The system of claim 24, wherein the request is received automatically from the particular managed server in response to the particular managed server booting up.

26. The system of claim 24, wherein:
receive from the particular managed server a request for an IP address for the particular managed server comprises receiving the request from a DHCP client associated with the particular managed server; and
causing the identified particular IP address to be communicated to the particular managed server comprises causing the identified particular IP address to be communicated to the DHCP client associated with the particular managed server.

27. The system of claim 19, wherein each geographic identifier identifies one of the plurality of possible physical locations for managed servers.

28. The system of claim 19, wherein:
the particular managed server is located in a particular slot in a particular chassis in a particular rack; and
the geographic identifier for the particular managed server identifies the particular slot, the particular chassis, and the particular rack in which the particular managed server is located.

29. The system of claim 19, wherein the control module of the management server is further operable to:
receive an initialization notification from a management processor associated with the managed server that the management processor is powered on;
in response to receiving the initialization notification, request from the management processor associated with the managed server a MAC address associated with the managed server; and
receive from the management processor associated with the managed server the MAC address associated with the managed server.

30. The system of claim 29, wherein the control module of the management server is further operable to create a second address correlation between the received MAC address and the particular IP address determined to correspond to the received geographic identifier.

31. The system of claim 29, wherein the initialization notification is received automatically from the management processor in response to the management processor receiving power upon insertion of the managed server into a physical server location.

32. Logic encoded in media associated with a management server for assigning IP addresses to a plurality of managed servers coupled to the management server, the logic being operable to perform the following steps:
store, at least temporarily, a set of first address correlations, each first address correlation comprising a correlation between one of a plurality of geographic identifiers and one of a plurality of IP addresses, each geographic identifier identifying a possible physical location of a managed server;
receive at a management server from a particular managed server a geographic identifier at least partially identifying the physical location of the managed server;
determine from the set of first address correlations the particular IP address corresponding to the received geographic identifier; and
assign the particular IP address to the particular managed server.

33. The logic of claim 32, wherein the management server comprises a DHCP management server.

34. The logic of claim 32, further operable to perform the following steps:
receive at the management server from the particular managed server a MAC address associated with the particular managed server; and
create a second address correlation between the received MAC address associated with the particular managed server and the particular IP address determined to correspond to the geographic identifier at least partially identifying the physical location of the managed server.

35. The logic of claim 34, wherein the geographic identifier and the MAC address associated with the particular managed server are received at the management server from a management processor of the particular managed server.

36. The logic of claim 34, further operable to perform the following steps:
receive at the management server a request from the particular managed server for an IP address for the particular managed server, the request including the MAC address associated with the particular managed server;
identify the particular IP address determined to correspond to the received geographic identifier based at least on the MAC address received in the request and the second address correlation between that MAC address and the particular IP address; and
cause the communication of the identified particular IP address to the particular managed server.

37. The logic of claim 32, wherein each geographic identifier identifies one of the plurality of possible physical locations for managed servers.

38. The logic of claim 37, wherein:
the particular managed server is located in a particular slot in a particular chassis in a particular rack; and
the geographic identifier for the particular managed server identifies the particular slot, the particular chassis, and the particular rack in which the particular managed server is located.
